(19) United States
(12) Patent Application Publication
(10) Pub. No.: US 2020/0089910 A1
(43) Pub. Date: Mar. 19, 2020

(54) MESSAGE PRIVACY

(71) Applicant: CELL BUDDY NETWORK LTD., Tel Aviv (IL)

(72) Inventors: Ofir Paz, Rishon LeZion (IL); Erez Doron, Tel Aviv (IL); Eyal Arbabof, Salit (IL)

(21) Appl. No.: 16/476,882

(22) PCT Filed: Jan. 10, 2018
(86) PCT No.: PCT/IL2018/050037

§ 371 Date: Jul. 10, 2019

Related U.S. Application Data
(60) Provisional application No. 62/444,387, filed on Jan. 10, 2017.

(51) Int. Cl. G06F 21/62; H04L 12/58

(52) U.S. Cl. CPC G06F 21/6245; H04L 51/16

(57) ABSTRACT

The disclosure provides a method for privately annotating a thread of a conversation between a participant and at least one other participant in a computer-based chat function. The disclosure also provides a method for hiding one or more messages in an existing thread of a chat conversation.

### RELATED APPLICATIONS

The present application claims benefit under 35 U.S.C. 119(e) of U.S. Provisional Applications 62/444,387 filed on Jan. 10, 2017, the disclosure of which is incorporated herein by reference.

### TECHNICAL FIELD

Embodiments of the disclosure relate to computer-based communication.

### BACKGROUND

A wide variety of communication platform applications with a messaging functionality are typically available for download in computer devices, including smartphones, tablets, laptop computer, and desktop computers. Commercial examples of downloadable communication platform applications include WhatsApp®, Skype®, Google Hangouts®, WeChat®, Viber®, Facebook Messenger® and the like. SMS (short message service) is also available as a default feature on most commercially available smartphones. A messaging functionality within communication applications are typically referred to as a “chat” function. A chat function enables a “chat conversation” comprising a sequence of entries of text, images, or video clips shared between two or more participants of the chat conversation. Each entry by a participant may be generically referred to as a “message”. Typically, new message in a conversation is displayed as a new entry below the previously entered messages, such that an ongoing conversation appears as a series of descending entries, with each new message appearing below the previous message. The sequence of messages exchanged during a conversation, at least a portion of which may be displayed in a window of a computer running the chat function, is typically referred to as a “thread”.

Many modern email applications may display emails exchanges between a group of two or more individuals as a thread, with each new email or the first few lines thereof displayed as a new entry below previously sent emails, such that a series of emails exchanged between the group appearing as a series of descending messages. Unless specified otherwise, the term chat function as used herein may be understood to include an email application operable to display email messages as a thread, a message, as used herein, includes emails, and a thread of messages includes a thread of emails.

### SUMMARY

An aspect of an embodiment of the disclosure relates to providing a method and system for annotating an existing message thread with a private note comprising text, image(s), or video clip(s) that is visible to the participant writing the private note but not to other participants in the thread.

For convenience of presentation, a private note in accordance with an embodiment of the disclosure may be referred to as a “selfnote”. The method in accordance with an embodiment of the disclosure may be referred to, respectively, as a “selfnote method”.

A selfnote method in accordance with an embodiment of the disclosure provides a method for entering an annotation message into a thread of a conversation between a first participant and at least one other participant, the thread comprising a plurality of messages. In an embodiment of the disclosure, a selfnote method comprises: registering the first participant's selection of a desired location in the thread; displaying a message entry field responsive to the selection of the desired location; registering entry of an annotation message into the message entry field; and displaying the annotation message in the thread shown to the first participant, wherein the annotation message is not shown in the thread as shown to the at least one other participant.

Optionally, the message or the annotation message comprises a string of characters, an image or a video clip, or any combination of one or more thereof.

Optionally, the desired location comprises a location above a message, below a message, or in between two messages. Alternatively, the desired location comprises a location within a message.

Another aspect of an embodiment of the disclosure relates to providing a method and system for hiding one or more messages in an existing message thread. The method in accordance with an embodiment of the disclosure may be referred to, respectively, as a “message hiding method”.

A message hiding method in accordance with an embodiment of the disclosure comprises: registering a selection of one or more messages in a thread displayed in a window of a communication application; hiding the selected one or more messages from the thread.

In an embodiment of the disclosure, the hidden one or more messages become hidden in the thread as displayed to a participant that hid the one or more messages. In an embodiment of the disclosure, the hidden messages become unable to be viewed by any of the participants of the conversation.

In an embodiment of the disclosure, the method further comprises: registering entry of a passcode associated with the hidden one or more messages; and revealing the hidden one or more messages in the thread, responsive to the entered passcode.

Optionally, the revealing of the hidden messages is applied only to the thread as presented to the participant that enters the passcode. Optionally, the revealing of the hidden messages is applied to the thread as viewed by all the participants in the conversation.

Optionally, the passcode is registered by entering the passcode into a text entry field comprised in the communication application. The text entry field is optionally a message entry field or a search field.

Optionally, the registering of the selection of the one or more messages to be hidden triggers a passcode entry field for creating the passcode.

In an embodiment of the disclosure, a chat application operable to perform a selfnote method or a hidden message method in accordance with an embodiment of the disclosure is executed by a processor in a computer device in accordance with computer executable instructions stored in a memory comprised in the computer device, which may optionally be a mobile phone, a smartphone, a laptop computer, a tablet computer or a desktop computer.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1 is a diagram of an exemplary environment on which embodiments of the disclosure are operable;

FIG. 2 shows a flowchart illustrating a selfnote method in accordance with an embodiment of the disclosure;

FIGS. 3A-3G schematically shows a sequence of mobile phone screens depicting an exemplary operation in a chat function of a selfnote method in accordance with an embodiment of the disclosure;

FIG. 4 shows a flowchart illustrating a hidden message method in accordance with an embodiment of the disclosure;

FIGS. 5A-5D schematically shows a sequence of mobile phone screens depicting an exemplary operation in a smartphone of a hidden message method in accordance with an embodiment of the disclosure; and

FIGS. 6A-6B schematically shows a sequence of mobile phone screens depicting an exemplary operation in a chat function of a revealing of a message hidden through a hidden message method in accordance with an embodiment of the disclosure.

### DETAILED DESCRIPTION

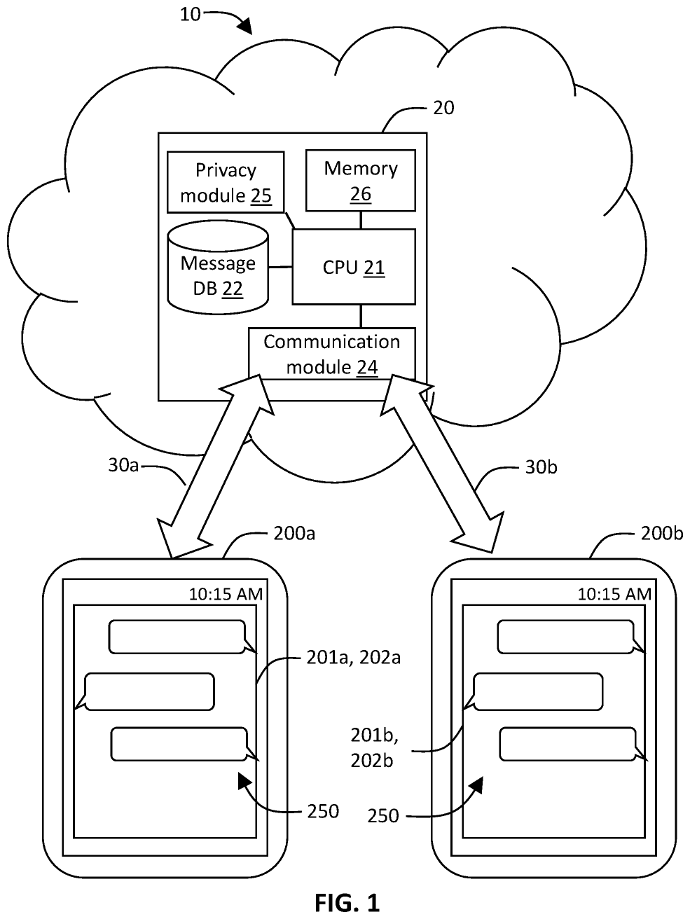

FIG. 1 shows an exemplary environment in which embodiments of the present disclosure may be operable. FIG. 1 schematically shows a network 10 to which a messaging system 20 is linked. Network 10 is, by way of example, a communications network comprising any combination of one or more of: cellular networks, private networks and wide area networks, including public networks such as the Internet. “Linked” as used herein includes both wired or wireless links, either direct or indirect, and placing the computers, including, servers, machines, computer components and the like, in electronic and/or data communications with each other.

In an embodiment of the disclosure, messaging system 20 is operable to receive messages signals (“message signals”) encoding messages of a thread from computer operated by a participant of the thread, and broadcast a copy of the messages signal to the computer being operated by each of the other participants of the thread, so that each computer is able to display an up-to-date thread as messages are added to the thread by the participants. FIG. 1 schematically shows computers 200a and 200b being operated by participants of a thread 250. Computer 200a is shown with a window 201a displaying messages of a thread 250, in a chat function 202a being executed by computer 200a. Computer 200b is shown with a window 201b displaying messages of a thread 250, in a chat function 202b being executed by computer 200b. A “computer” as used herein, for example computers 200a and 200b as shown in FIG. 1, includes mobile devices such as mobile computers and mobile computing devices, which link to networks, which are commonly used as telephones, as well as tablets, laptop and desktop computers.

FIG. 1 also shows an architecture of messaging system 20 in accordance with an embodiment of the disclosure, which is a special purpose computer comprising a central processing unit (CPU) 21 formed of one or more processors, that is operatively connected with a memory 26, and a communication module 24. In an embodiment of the disclosure, messaging system 20 comprises a message database (DB) 22 operable to store received and broadcast messages. In an embodiment of the disclosure, messaging system 20 comprises a privacy module 25 operable to control access of a given thread or a message within a thread to a given participant or a computer operated by the participant.

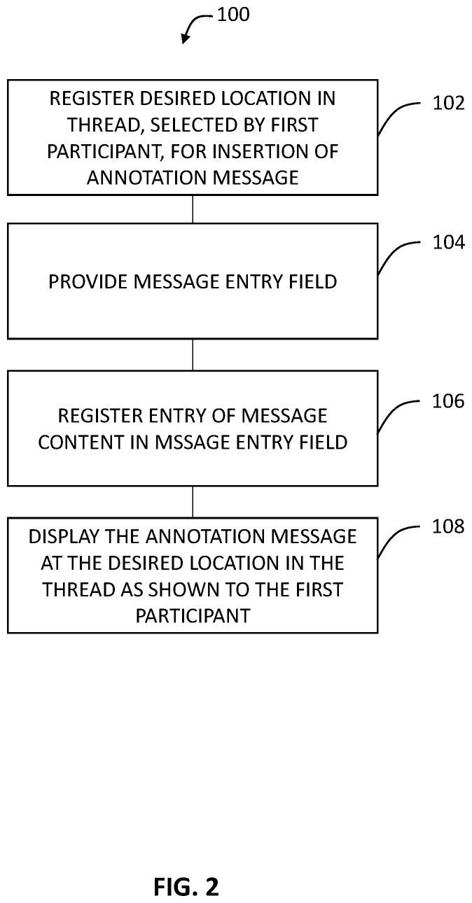

CPU 21 is formed of one or more processors, including microprocessors, and operable controlling one or more of memory 26, message DB 22, privacy module 25 and communication module 24 to perform a selfnote method and/or a message hiding method in accordance with an embodiment of the disclosure, for example as shown in FIGS. 2, 3A-3G, 4 and 5A-5D, and as described herein. The processors are, for example, conventional processors, such as those used in servers, computers, and other computerized devices.

Memory 26 optionally comprises any conventional storage media. Memory 26 optionally stores machine executable instructions for execution by CPU 21, to perform a selfnote method and/or a message hiding method in accordance with an embodiment of the disclosure.

Communication module 24 is operable to send and receive signals, including message signals, to and from one or more computers, including computer 200a via a communication channel schematically represented by double sided block arrow 30a and computer 200b via a communication channel schematically represented by double sided block arrow 30b, as well as other computers (not shown) that may be participating in a thread.

Each of the various components of messaging system 20, although schematically shown as a single component for representative purposes, may be comprised of multiple components. While messaging system 20 is schematically shown as a physically integrated apparatus, components of the system may be in disparate nodes connected to network 100. While messaging system 20 is schematically shown as separate components that appear to be hardware components, messaging system 20 is optionally a “virtualized” system defined by software components comprised in one or more nodes connected to network 100.

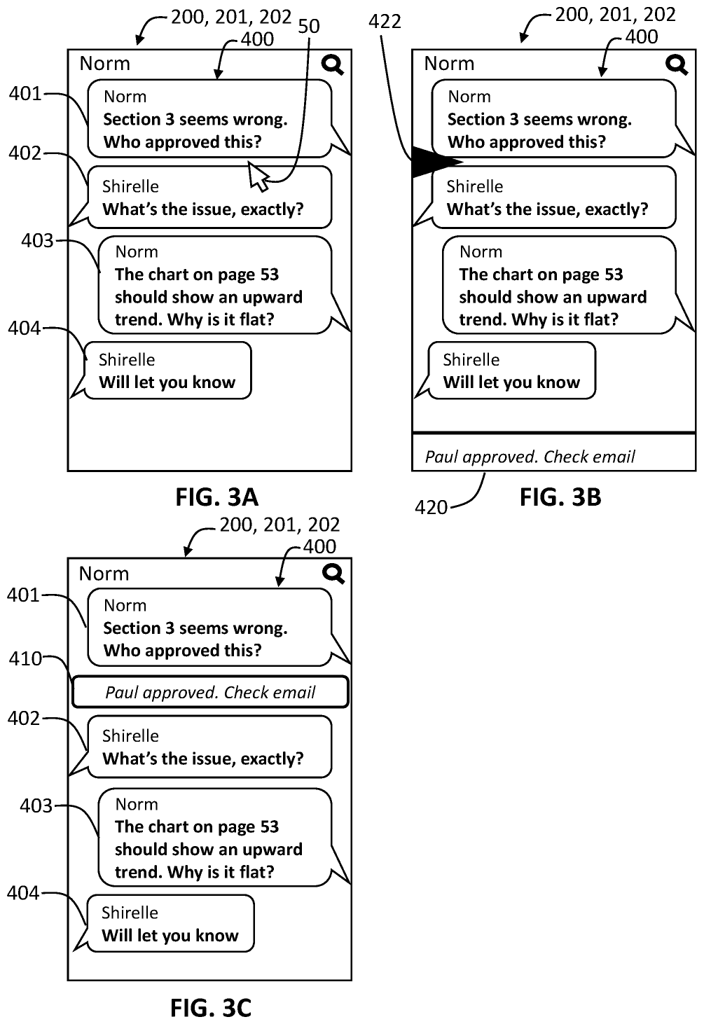

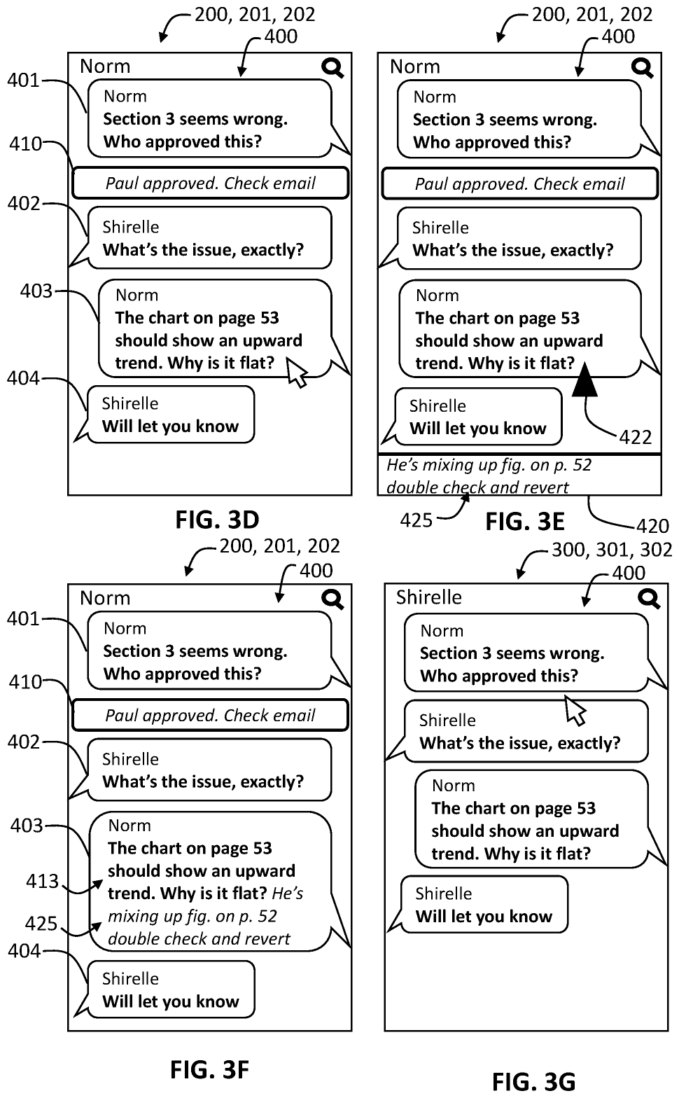

Reference is made to FIG. 2, which shows a flowchart illustrating a selfnote method 100 in accordance with an embodiment of the disclosure. Reference is also made to FIGS. 3A-3G, which schematically depict an exemplary operation of selfnote method 100. While selfnote method 100 is describe hereinbelow with respect to a computer 200 running a chat application and being operated by a participant in a thread, in certain embodiments of the disclosure, a complementary method is also performed from the perspective of messaging system 20.

Method 100 in accordance with an embodiment of the disclosure, which may be executed by a chat function operating on a computer, comprises registering a selection of a desired location in a message thread (Block 102), providing a message entry field responsive to the selection of the desired location (Block 104), registering entry of an annotation message into annotation entry field (Block 106) and displaying the annotation message in the thread at the desired location (Block 108). In an embodiment of the disclosure, the annotation message is visible to the participant of the conversation that entered the annotation message but not to other participants. Optionally, the message or the annotation message comprises a string of characters, an image or a video clip, or any combination of one or more thereof.

Block 102 of method 100 in accordance with an embodiment of the disclosure is shown by way of example in FIG. 3A. FIG. 3A schematically shows a window 201 of a chat function 202 being executed by a computer 200. The operator of computer 200, named Shirelle, is participating in a chat conversation with Norm, who is operating another computer 300 (not shown in FIG. 3A). Window 201 displays messages 401-404 comprised in a thread 400. In message 401, Norm asks Shirelle “Section 3 seems wrong. Who approved this?” Shirelle wishes to add an annotation message with a tentative answer to the question that would not be visible to Norm. To begin selfnote method 100 for entering the annotation message, Shirelle double clicks on an area below message 401 to indicate her desired location for placing the annotation message. The location of the double click on the desired location is schematically indicated in FIG. 3A with a pointer 50.

The desired location may alternatively be selected through other actions such a long click, a single click, hovering, or other actions typically used to indicate selection in a graphical user interface. The action may be registered, by way of example, through a mouse, a touchpad, or a touchscreen. While as shown in FIG. 3A, Shirelle chose a location between two messages, the desired location for entering an annotation message may alternatively be within an existing message in the thread.

Blocks 104 and 106 in accordance with an embodiment of the disclosure are shown by way of example in FIG. 3B. Shirelle's selection of the desired location (as shown in FIG. 3A) triggers the chat function to provide annotation entry field 420 (Block 104), which registers an annotation entered therein (Block 106). As shown in FIG. 3B, Shirelle types “Paul approved. Check email” into annotation entry field 420. FIG. 3B also shows an optional placement indicator 422, which indicates the desired location selected in Block 102 and notes where the annotation entered into annotation entry field 420 will appear.

Block 108 in accordance with an embodiment of the disclosure is shown by way of example in FIG. 3C. After Shirelle approves the annotation message entered into annotation entry field 420 (for example by pressing “Enter” on the keyboard), the annotation message is displayed in thread 400 as the desired located selected in Block 102. As shown in FIG. 3C, the annotation message may be displayed as a new annotation message 410 between messages 401 and 402, and annotation message 410 may be displayed differently from the existing messages for easy differentiation.

FIGS. 3D-3F shows an alternative embodiment of selfnote method 100, in which an annotation message is added within an existing message. After Shirelle creates annotation message 410, she wishes to add annotation message 425 into message 403. Shirelle selects the end of the original text within message 403 as the desire location for adding annotation message (FIG. 3D), which triggers an appearance of message entry field 420 and placement indicator 422 (FIG. 3E). Shirelle types “He's mixing up fig. of p. 52 double check and revert” as annotation message 425, into message entry field 420. Upon Shirelle's approval of annotation message 425, the annotation message is displayed after original text 413 of message 403, at the selected desired location (FIG. 3F).

As noted above, in accordance with an embodiment of the disclosure, annotation message created by one participant in a chat conversation is visible only to that one participant, and the appearance of the thread remains unchanged for the other participants in the conversation. FIG. 3G shows a window 301 of a chat function 302 being executed by a computer 300, displaying the same thread 400 shown in FIGS. 3A-3F as presented to Norm, the other participant in the chat conversation with Shirelle. Because Shirelle, not Norm, created the annotation message, chat function 302 does not display any annotation message in thread 400 as presented to Norm. Conversely, if Norm enters annotation message into thread 400, the annotation message would be presented to Norm but not to Shirelle.

In an embodiment of the disclosure, data encoding a selfnote is stored in a memory in the computer through which the selfnote was created. By way of example, data encoding selfnote 410 by Shirelle is stored in a memory comprised in Shirelle's computer 200. Optionally, data encoding a selfnote is not transmitted to messaging system 20 or stored in message DB 22. As a result, the selfnotes would not be available to be shown to other participants of the same thread, who receives the messages of the thread from messaging system 20. Alternatively or additionally, data encoding a selfnote is transmitted to messaging system 20 and stored in message DB 22, and privacy module 25 maintains a record of user accounts, which user account is associated with a given selfnote, and manages access of the selfnotes. Optionally, data encoding a given selfnote stored in message DB 22 is broadcast only to a computer accessing message server 20 through a user account given permission by privacy module 25 to receive the selfnote data, by way of example a user account that created the given selfnote. As a result, Shirelle would still be able to view her selfnotes if she the thread from a different computer device, provided that she accesses the thread with her user account. Optionally, one user could provide permission to a selected other user to view the selfnote in the thread as shown to the other user.

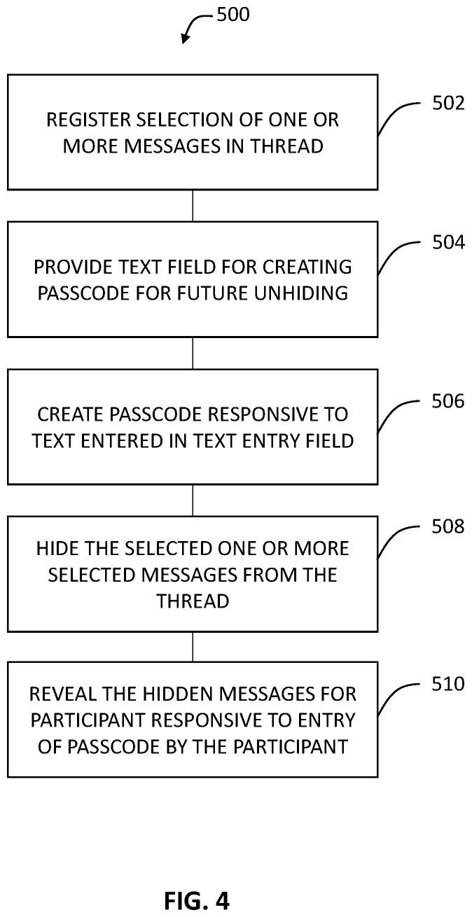

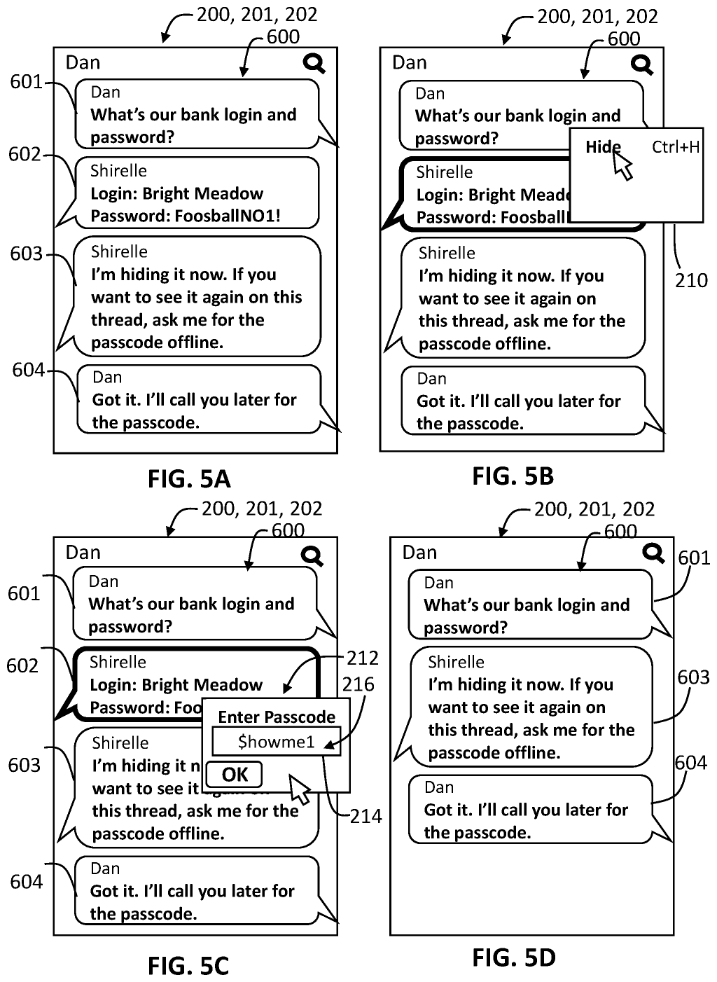

Reference is made to FIG. 4, which shows a flowchart illustrating a hidden message method 500 in accordance with an embodiment of the disclosure. Reference is also made to FIGS. 5A-5D, which schematically depicts an exemplary operation of hidden message method 100. While FIGS. 5A-5D depict by way of example a window of a chat function running on a desktop or laptop computer, similar examples may be provided by showing a sequence of screenshots of a touchscreen of a smartphone. While hidden message method 500 is describe hereinbelow with respect to a computer 200 running a chat application and being operated by a participant in a thread, in certain embodiments of the disclosure, a complementary method is also performed from the perspective of messaging system 20.

Hidden message method 500 in accordance with an embodiment of the disclosure, which may be executed by a chat function, comprises registering selection of one or more messages in a thread of a chat conversation (Block 502), and hiding the selected one or more messages from the thread, such that the selected one or more messages become unable to be viewed by all participants of the conversation (Block 508).

In an embodiment of the disclosure, a participant of the conversation may reveal the hidden messages by providing to the chat function a passcode. As such, hidden message method 500 may further comprise revealing the hidden messages for a participant responsive to entry of a passcode (Block 510).

Optionally, the participant selecting and hiding the one or more messages may be prompted to create the passcode to be used for future revealing of the one or more messages. As such, hidden message method may further comprise providing a passcode entry field responsive to the selection of the one or more messages (Block 504), and creating a passcode responsive to a string of characters entered in the passcode entry field (Block 506).

FIG. 5A schematically shows a window 201 of a chat function 202 being executed by a computer 200. The operator of computer 200, Shirelle, is participating in a chat conversation with Dan, who is operating another computer 350 (not shown in FIG. 5A). Window 201 displays messages 601-604 comprised in a thread 600. In message 601, Dan asks Shirelle “What's our bank login and password?” In response, Shirelle provides the requested login and password in message 602. However, because a bank login and password are sensitive pieces of information, Shirelle wants to hide message 602, in case another party accidentally or maliciously gains access to her computer and/or her account for the chat function.

Block 502 of hidden message method 500 (FIG. 4) in accordance with an embodiment of the disclosure, relating to selecting messages to hide, is shown by way of example in FIG. 5B. Shirelle selects message 602 and opens a menu 210 of actions to be done to the selected message. Menu 210 may be opened by way of example by right-clicking or by entering a keyboard-based command. In an embodiment of the disclosure, menu 210 includes a “Hide” option.

Block 504 and 506 of hidden message method 500 (FIG. 4) in accordance with an embodiment of the disclosure, relating to creating a passocode to reveal hidden messages, is shown by way of example in FIG. 5C. After Shirelle instructs chat function 202 to hide message 602, the application prompts Shirelle to create a passcode to be used for future revealing of message 602, by opening passcode window 212 having a passcode entry field 214. Shirelle types in a passcode 216 (“$howme1” as shown in FIG. 5C). The newly created passcode is saved and associated with message 602 for revealing message 602.

In certain embodiment of the disclosure, a passcode created by a participant hiding one or more messages in a thread may be associated with said one or more messages. Alternatively, the passcode may be associated with all messages hidden by the participant during the conversation including messages hidden after the creation of the passcode, such that the passcode is operable to reveal all messages hidden by the participant over the course of the conversation. Alternatively or additionally, a participant may create a passcode operable to reveal any messages hidden by the participant in any conversation.

Block 508 (FIG. 4) in accordance with an embodiment of the disclosure, relating to hiding the selected messages, is shown by way of example in FIG. 5D. After the passcode is created and saved, chat function 202 hides message 602, so that thread 600 still displays messages 601, 603 and 604, but not message 602.

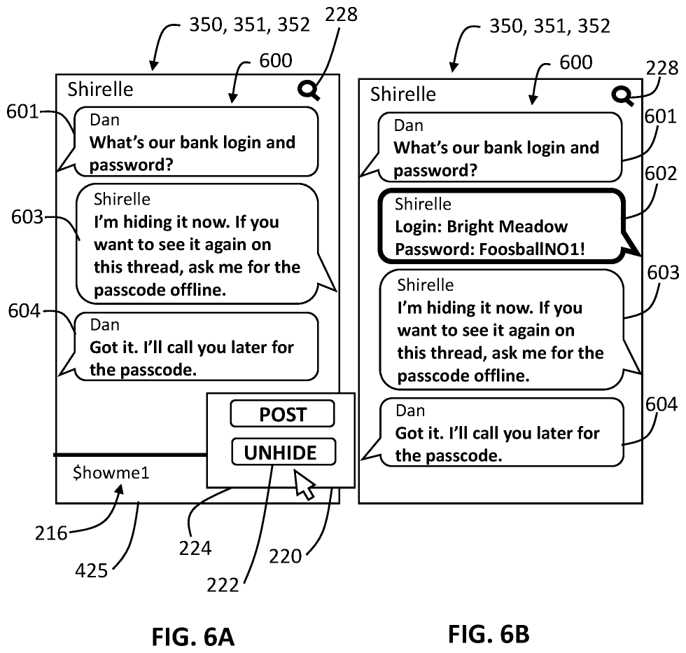

In an embodiment of the disclosure, the hidden one or more messages become hidden in the thread as displayed to a participant that hid the one or more messages. In such an embodiment, if Shirelle hides message 602, the message becomes hidden in thread 600 as displayed in computer 200 but remain visible as displayed in the computer of other participants. Alternatively, hidden messages become unable to be viewed by all or a selection of participants of the conversation. As such, if Shirelle hides message 602, the message becomes hidden not only in thread 600 displayed in computer 200 operated by Shirelle, but also becomes hidden in the thread for the same conversation displayed in Dan's computer 350. Reference is made to FIG. 5A that schematically shows a window 351 of a chat function 352 being executed by a computer 350. The operator of computer 350, Dan, is participating in a chat conversation with Shirelle. FIG. 6A shows window 350 showing thread 600 after Shirelle has hidden message 602 (as shown in FIGS. 5A-5D and described above). As such, thread 600 as displayed to Dan in window 351 displays messages 601, 603 and 604 but does not display hidden message 602.

Optionally, the one or more messages that are hidden may include all messages in a thread. In such a case, the hidden thread is optionally displayed as an empty thread devoid of messages. Optionally, the other participant in the hidden thread is also hidden on a contact list for the chat function. By way of example, in a case where Shirelle hides all messages of thread 600 for her conversation with Dan, Dan also become hidden in the contact list (not shown) for chat function 202 as displayed in Shirelle's computer 200.

In an embodiment of the disclosure, a participant of the conversation may reveal the hidden messages by providing to the chat function a passcode. As such, hidden message method 500 may further comprise revealing the hidden messages for a participant responsive to entry of a passcode (Block 510). Optionally, the passcode comprises a string of characters.

In an embodiment of the disclosure any participant in the conversation, including a participant that did not hide the hidden message, may reveal a previously hidden message upon entering a passcode created (in Blocks 504 and 506) for revealing the hidden message. Optionally, if a given participant reveals a message that was originally hidden by another participant, the hidden messages become visible in the thread as presented to the given participant, but the visibility of the hidden messages in the thread as presented to other participants of the conversation are not affected. Optionally, the participant that originally hid the hidden messages, may be presented with an option to make the hidden messages become visible again for all participants of the conversation.

In an embodiment of the invention, hidden message method 500 may proceed directly from Block 502 (selecting messages for hiding) to Block 508 (hiding the selected messages), and skip the Blocks 504 and 506 relating to creating of a new passcode for revealing the hidden messages. In such an embodiment, a passcode was created and saved earlier, or alternatively, the hidden messages become permanently hidden and cannot later be revealed.

With reference to FIG. 6A, in an embodiment of the disclosure, chat function 352 detects previously created passcode 216 being entered by participant Dan in a message entry field 425. In an embodiment of the disclosure, a string of characters entered into message entry field 425 is compared against a record of passcodes associated with the thread to detect a string of characters that may be intended to be entered to unhide previously hidden messages rather than be entered as a new message. upon detecting entry of passcode 216, chat function 352 opens a selection window 220 that prompts Dan to select an “UNHIDE” button 222 if he intends the text of passcode 216 to operate as a passcode and reveal corresponding hidden messages, or to select a “POST” button 224 if he intends the text of passcode 216 to operate as normal text to be entered as a new message.

With reference to FIG. 6B, after Dan selects “UNHIDE” button 222, passcode 216 is registered as the passcode previously created by Shirelle when hiding message 602, and chat function 352 reveals message 602 in thread 600 as displayed in computer 350 and viewed by Dan.

In an embodiment of the disclosure, passcode 216 may be registered in one of any text entry field accessible from window 351. Optionally, the text entry field is message entry field 425 typically used for entering a new message, as shown in FIG. 6A. Alternatively or additionally, the text entry field is a message search field operable to initiate a search in the thread that is, for example, accessed by clicking on a magnifying glass icon 228 as shown in FIGS. 6A and 6B.

In an embodiment of the disclosure, data encoding a hiding status of a message is stored in a memory comprised in the computer through which the message was hidden. By way of example, data encoding the “hidden” status of message 602 is stored in a memory comprised in Shirelle's computer 200. Optionally, data encoding the “hidden” status is not transmitted to messaging system 20 or stored in message DB 22. As a result, the hidden message would remain visible to other participants of the same thread, while anyone that gained unauthorized access to Shirelle's user account would still not be able to view hidden message 602, unless the unauthorized party was also aware of how to unhide hidden messages the message and was in possession of the passcode to UNHIDE message 602.

In an embodiment of the disclosure, data encoding a hiding status for a message is transmitted to messaging system 20 and stored in message DB 22, and privacy module 25 maintains a record of user accounts, which user account is associated with a given hiding status of a given message, and manages access of the hidden message accordingly. Optionally, data encoding a hidden status stored in message DB 22 is broadcast to a computer accessing message server 20 through a user account assigned to have a given message be hidden in accordance with privacy module 25.

Optionally, a passcode and data associating the passcode to the hidden message is stored in a memory comprised in the computer through which the message was hidden. Additionally or alternatively, the passcode and data associating the passcode to the hidden message is transmitted to messaging system 20 and stored in privacy module 25. As such, in an embodiment of the disclosure, privacy module 25 is operable to maintain a record of passocodes for unhiding messages associated with a given hidden message or a given thread. As a result, by way of example as shown in FIGS. 6A-6B, Dan would be able to view message 602 hidden by Shirelle, provided that Dan enters passcode 216.

While the above examples are presented in the context of a chat functionality, embodiments of selfnote method 100 and hidden message method 500 as described hereinabove may be executed in an email application that presents emails exchanged between a group of email addresses as a thread. In addition, while the above examples are presented in the context of a chat function running on a desktop or laptop computer, selfnote method 100 and hidden message method 500 as described hereinabove may be executed in a smartphone or tablet computer, with the messages being viewed and manipulated through a touchscreen.

There is therefore provided, in an aspect of the disclosure, a method for privately annotating a thread of a conversation between a participant and at least one other participant in a computer-based chat function, the method comprising: registering the participant's selection of a desired location in the thread for entering an annotation message; providing a message entry field for entry of the annotation message by the participant, responsive to the selection of the desire location; registering entry of the annotation message in the message entry field; and displaying the annotation message in the thread at the desired location, wherein the annotation message is visible to the participant but not visible to the at least one other participant. Optionally, the desired location comprises a location within an existing message. Optionally, the desired location comprises a location outside of an existing message.

In an embodiment of the disclosure, the annotation message comprises one or a combination of two or more of: a string of characters, an image and a video clip.

In an embodiment of the disclosure, the selection of the desired location in the thread is an action indicating selection performed on a graphical user interface (GUI). Optionally, the action performed on the GUI is registered by a mouse, a touchpad, or a touchscreen.

There is also provided, in another aspect of the disclosure, a method for hiding one or more messages in an existing thread of a chat conversation, the method comprising: registering selection of one or more messages in the thread by a participant of the thread; and hiding the selected one or more messages from the thread, such that the hidden one or more messages become unable to be viewed.

Optionally, the hidden one or more messages become hidden in the thread as displayed to the participant that hid the one or more messages. Optionally, the hidden one or more messages remain unhidden in the thread as viewed by other participants of the conversation. Optionally, the hidden one or more messages become hidden in the thread as viewed by other participants of the conversation. Optionally, the hidden one or more messages comprise all messages of the thread.

In an embodiment of the disclosure, the method further comprises creating a passcode for recovering the hidden one or more messages. Optionally, creating the passcode comprises: displaying a passcode creation prompt comprising a passcode entry field; registering a string of characters entered into the passcode entry field; and designating the registered character string as the passcode.

There is also provided, in another aspect of the disclosure, a method for revealing a message previously hidden in a thread, the method comprising: registering entry of a passcode associated with the previously hidden message; and revealing the previously hidden message in the thread responsive to the entered passcode. Optionally, the passcode comprises a string of characters entered into a message entry field that is operable to register entry of a new message for the thread or a search field that is operable to initiate a search in the thread.

Optionally, revealing the hidden one or more messages comprises comparing the string of characters against a record of passcodes associated with the thread to confirm the string of characters as a passcode. Optionally, revealing the hidden one or more messages comprises displaying a prompt to provide a confirmation that the string of characters is intended to be used as the passcode, and revealing the hidden one or more messages responsive to registering the confirmation.

There is also provided, in another aspect of the disclosure, a computer device comprising a processor and a memory storing computer executable instructions for execution by the processor, wherein the processor, responsive to the executable instructions, is operable to perform any one or more of the above-described methods. Optionally, the computer device is selected from the group consisting of a mobile phone, a smartphone, a laptop computer, a tablet computer or a desktop computer.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

1. (canceled)

2. (canceled)

3. (canceled)

4. (canceled)

5. (canceled)

6. (canceled)

7. (canceled)

8. (canceled)

9. A method for hiding one or more messages in an existing thread of a chat conversation, the method comprising:
registering selection of one or more messages in the thread by a participant of the thread; and
hiding the selected one or more messages from the thread, such that the hidden one or more messages become unable to be viewed.

10. The method according to claim 9, wherein the hidden one or more messages become hidden in the thread as displayed to the participant that hid the one or more messages.

11. The method according to claim 10, wherein the hidden one or more messages remain unhidden in the thread as viewed by other participants of the conversation.

12. The method according to claim 9, wherein the hidden one or more messages become hidden in the thread as viewed by other participants of the conversation.

13. The method according to claim 9, wherein the hidden one or more messages comprise all messages of the thread.

14. The method according to claim 9, further comprising creating a passcode for recovering the hidden one or more messages.

15. The method according to claim 14, wherein creating the passcode comprises:
displaying a passcode creation prompt comprising a passcode entry field;
registering a string of characters entered into the passcode entry field; and
designating the registered character string as the passcode.

16. The method according to claim 9 further comprising:
registering entry of a passcode associated with the hidden one or more messages by a participant of the conversation; and
revealing the hidden one or more messages in the thread as presented to the participant, responsive to the entered passcode.

17. The method according to claim 16, wherein the passcode comprises a string of characters entered into a message entry field that is operable to register entry of a new message for the thread or a search field that is operable to initiate a search in the thread.

18. The method according to claim 17, comprising comparing the string of characters against a record of passcodes associated with the thread to detect the string of characters as a passcode.

19. The method according to claim 18, comprising displaying a prompt to provide a confirmation that the string of characters is intended to be used as the passcode, and revealing the hidden one or more messages responsive to registering the confirmation.

20. A method for revealing a message previously hidden in a thread, the method comprising:
registering entry of a passcode associated with the previously hidden message; and
revealing the previously hidden message in the thread responsive to the entered passcode.

21. The method according to claim 20, wherein the passcode comprises a string of characters entered into a message entry field that is operable to register entry of a new message for the thread or a search field that is operable to initiate a search in the thread.

22. The method according to claim 21, comprising comparing the string of characters against a record of passcodes associated with the thread to detect the string of characters as a passcode.

23. The method according to claim 22, comprising displaying a prompt to provide a confirmation that the string of characters is intended to be used as the passcode, and revealing the hidden one or more messages responsive to registering the confirmation.

24. A computer device comprising a processor and a memory storing computer executable instructions for execution by the processor, wherein the processor, responsive to the executable instructions, is operable to perform the method of claim 9.

25. The computer device according the claim 24, selected from the group consisting of a mobile phone, a smartphone, a laptop computer, a tablet computer or a desktop computer.

26. A computer device comprising a processor and a memory storing computer executable instructions for execution by the processor, wherein the processor, responsive to the executable instructions, is operable to perform the method of claim 20.

27. The computer device according the claim 26, selected from the group consisting of a mobile phone, a smartphone, a laptop computer, a tablet computer or a desktop computer.
